(19) United States
(12) Patent Application Publication
(10) Pub. No.: US 2012/0206740 A1
(43) Pub. Date: Aug. 16, 2012

(54) PRINTER AND POWER SUPPLY DEVICE FOR A PRINTER

(75) Inventor: Kazuyuki Yoshikoshi, Shizuoka (JP)

(73) Assignee: TOSHIBA TEC KABUSHIKI KAISHA, Tokyo (JP)

(21) Appl. No.: 13/371,548

(22) Filed: Feb. 13, 2012

(30) Foreign Application Priority Data
Feb. 15, 2011 (JP) 2011-29605

(51) Int. Cl. G06K 15/10

(52) U.S. Cl. 358/1.8

(57) ABSTRACT

A printer for performing a printing operation with a printing head is disclosed. The printer comprises: a load power supply configured to supply a printing current to the printing head through a head drive circuit; and a logic power supply configured to supply a current to a control unit. The control unit is configured to transmit a print signal to the head drive circuit to control the printing head. The load power supply and the logic power supply are separately generated by performing independent AC-DC conversions of an AC power supply.

### CROSS-REFERENCE TO RELATED APPLICATIONS

This application is based upon and claims the benefit of priority from Japanese Patent Application No. 2011-029605 filed on Feb. 15, 2011, the entire content of which are incorporated herein by reference.

### FIELD

Embodiments described herein relate generally to a printer and a power supply device for a printer.

### BACKGROUND

A conventional power supply device for a printer has a load power supply for supplying a current to a drive system such as a printing head, a stepping motor, a DC motor, a logic power supply for supplying a current to a logic system such as a control unit, a communication unit and a sensor unit. The load power supply (at the secondary side) is separately generated by performing AC-DC conversion at the side of an AC power supply (at the primary side). The logic power supply is generated from the load power supply.

However, the two power supplies (load and logic power supplies) work at all times. Thus, the power loss is high especially in the load power supply and the power consumption in the power supply device itself becomes extremely high.

Given the above, it is an object of the embodiments disclosed herein to provide a power supply device for a printer capable of generating load and logic power supplies by performing independent AC-DC conversions when a primary side current is converted to a secondary side current.

### BRIEF DESCRIPTION OF THE DRAWINGS

FIG. 1 is a block diagram showing the configuration of a printer.

FIG. 2 is a flowchart showing a routine executed during the operation of a power supply device for a printer.

### DETAILED DESCRIPTION

According to one embodiment, a printer for performing a printing operation with a printing head comprises: a load power supply configured to supply a printing current to the printing head through a head drive circuit; and a logic power supply configured to supply a current to a control unit for transmitting a print signal to the head drive circuit to control the printing head, the load power supply and the logic power supply being separately generated by performing independent AC-DC conversions of an AC power supply.

According to another embodiment, a power supply device for a printer for performing a printing operation with a printing head comprises: a load power supply configured to supply a printing current to the printing head through a head drive circuit; and a logic power supply configured to supply a current to a control unit for transmitting a print signal to the head drive circuit to control the printing head, the load power supply and the logic power supply being separately generated by performing independent AC-DC conversions of an AC power supply.

A printer and a power supply device for a printer according to the present embodiments will now be described with reference to the drawings. The following description is directed to an instance where the embodiments are applied to a barcode printer.

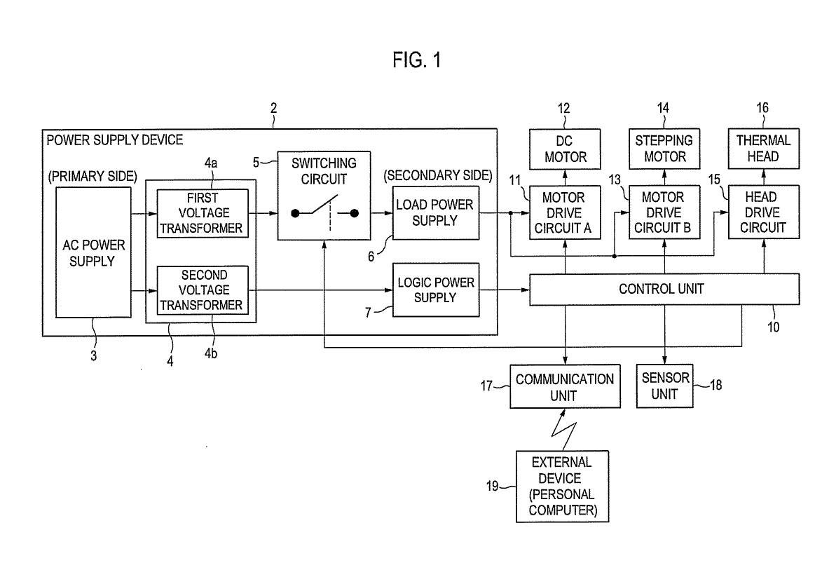

FIG. 1 is a block diagram showing the configuration of a printer according to one embodiment. Referring to FIG. 1, the printer 1 is a barcode printer and includes a power supply device 2, a control unit 10, a motor drive circuit A 11, a DC motor 12, a motor drive circuit B 13, a stepping motor 14, a head drive circuit 15, a thermal head 16, a communication unit 17 and a sensor unit 18.

The power supply device 2 includes an AC power supply 3, a voltage transformer 4, a switching circuit 5, a load power supply 6 and a logic power supply 7. The voltage transformer 4 includes a first voltage transformer 4a and a second voltage transformer 4b. The AC power supply 3 is connected to a primary coil (not shown) of the first voltage transformer 4a and a primary coil (not shown) of the second voltage transformer 4b. The load power supply 6 is connected to a secondary coil (not shown) of the first voltage transformer 4a through the switching circuit 5. The logic power supply 7 is directly connected to a secondary coil (not shown) of the second voltage transformer 4b.

The control unit 10 serves to control the motor drive circuit A 11, the motor drive circuit B 13, the head drive circuit 15 and the switching circuit 5. The control unit 10 includes a CPU, an I/O port, a timer, etc. Responsive to a control signal received from the control unit 10, the motor drive circuit A 11 supplies a drive current to the DC motor 12 for use in feeding an ink ribbon. In response to a control signal received from the control unit 10, the motor drive circuit B 13 supplies a drive current to the stepping motor 14 for use in feeding a paper. Pursuant to a print signal received from the control unit 10, the head drive circuit 15 supplies a drive current to the thermal head 16. The thermal head 16 prints data using the drive current supplied by the head drive circuit 15. The communication unit 17 receives, through an interface, the print data transmitted from an external device (e.g., a personal computer). The print data thus received are stored in a memory (not shown) of the control unit 10. The sensor unit 18 comprises an infrared sensor or the like and is used to detect the alignment of a paper or the presence and absence of a paper.

The load power supply 6 (e.g., DC 27V) serves to supply a current to the DC motor 12, the stepping motor 14 and the thermal head 16. The current is supplied to the DC motor 12 through the motor drive circuit A 11, to the stepping motor 14 through the motor drive circuit B 13 and to the thermal head 16 through the head drive circuit 15. The load power supply 6 is connected to a secondary coil (not shown) of the first voltage transformer 4a through the switching circuit 5. The supply of the current from the AC power supply 3 and the first voltage transformer 4a to the load power supply 6 is controlled by the on/off operation of the switching circuit 5. In response to a control signal transmitted from the control unit 10, the switching circuit 5 performs the on/off operation to thereby control the supply of the current to the load power supply 6.

The logic power supply 7 (e.g., DC 5V) serves to supply a current to the control unit 10, the communication unit 17, the sensor unit 18 and the switching circuit 5. The logic power supply 7 is directly connected to a secondary coil (not shown) of the second voltage transformer 4b and is turned on and off in synchronization with the on/off operation of the AC power supply 3. If the AC power supply 3 is kept turned on, then the logic power supply 7 is always turned on to supply an operation current to the control unit 10, the communication unit 17, the sensor unit 18 and the switching circuit 5.

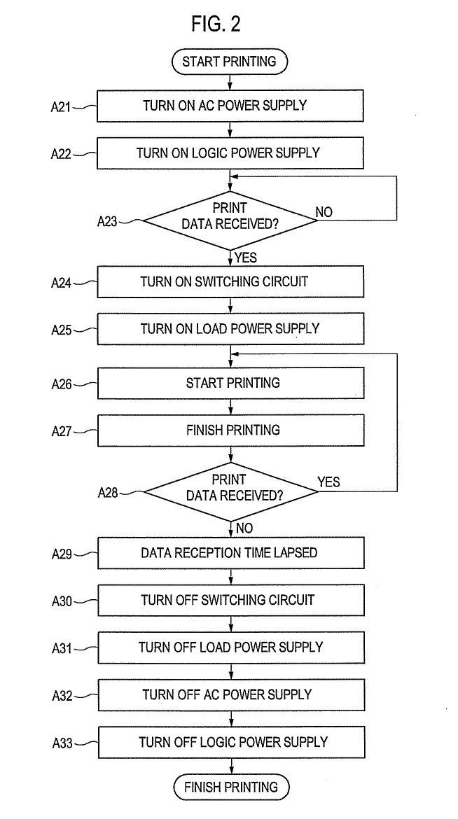

Next, description will be given on the operation of the power supply device 2 for the printer 1 described above. FIG. 2 is a flowchart showing a routine executed during the operation of the power supply device 2 for the printer 1.

In order to start a printing operation, the power supply (AC power supply 3) of the printer 1 is first turned on (action A21) and the logic power supply 7 is also turned on at the same time (action A22). Then, determination is made as to whether print data are received by the printer 1 (action A23). If the communication unit 17 of the printer 1 receives print data, then a control signal is outputted from the control unit 10 to turn on the switching circuit 5 (action A24). Thus, a current is supplied from the AC power supply 3 to the load power supply 6, thereby turning on the load power supply 6 (action A25). If the communication unit 17 of the printer 1 fails to receive print data, then the printer 1 waits while monitoring the reception of print data (action A23).

Subsequently, the load power supply 6 supplies a current to the DC motor 12, the stepping motor 14 and the thermal head 16 through the drive circuits 11, 13 and 15 to start a printing operation (action A26). Thereafter, if the printing operation of the printer 1 is finished (action A27), then the printer 1 comes into a printing standby state. If the communication unit 17 receives print data in the printing standby state, then the printing operation starts again (action A28). If the communication unit 17 fails to receive print data within a predetermined time (action A29), then a control signal is outputted from the control unit 10 to turn off the switching circuit 5 (action A30). Thus, the load power supply 6 is turned off (action A31). Thereafter, if the power supply (AC power supply 3) of the printer 1 is turned off to finish the printing operation (action A32), then the logic power supply 7 is also turned off at the same time (action A33).

According to the embodiments described above, the supply of a current from the AC power supply to the load power supply in the printer is selectively cut off as needed. This makes it possible to reduce the standby state power loss in the load power supply as much as possible.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus, or can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel printer and power supply device described herein may be embodied in a variety of other focus. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer for performing a printing operation with a printing head, comprising:
a load power supply configured to supply a printing current to the printing head through a head drive circuit; and
a logic power supply configured to supply a current to a control unit, the control unit being configured to transmit a print signal to the head drive circuit to control the printing head, the load power supply and the logic power supply being separately generated by performing independent AC-DC conversions of an AC power supply.

2. The printer of claim 1, wherein the load power supply is connected to the AC power supply through a switching circuit such that the supply of a current from the AC power supply to the load power supply is controlled by an on/off operation of the switching circuit.

3. The printer of claim 1, wherein the logic power supply is directly connected to the AC power supply such that the logic power supply is turned on and off in synchronization with the on/off operation of the switching circuit.

4. The printer of claim 1, further comprising:
a voltage transformer including a first voltage transformer and a second voltage transformer, the voltage transformer being configured to perform AC-DC conversion of the AC power supply,
wherein the first voltage transformer performs AC-DC conversion between the AC power supply and the load power supply, and the second voltage transformer performs AC-DC conversion between the AC power supply and the logic power supply.

5. A power supply device for a printer for performing a printing operation with a printing head, comprising:
a load power supply configured to supply a printing current to the printing head through a head drive circuit; and
a logic power supply configured to supply a current to a control unit, the control unit being configured to transmit a print signal to the head drive circuit to control the printing head, the load power supply and the logic power supply being separately generated by performing AC-DC conversion independently of an AC power supply.

6. The device of claim 5, wherein the load power supply is connected to the AC power supply through a switching circuit such that the supply of a current from the AC power supply to the load power supply is controlled by an on/off operation of the switching circuit.

7. The device of claim 5, wherein the logic power supply is directly connected to the AC power supply such that the logic power supply is turned on and off in synchronization with the on/off operation of the switching circuit.

8. The device of claim 5, further comprising:
a voltage transformer including a first voltage transformer and a second voltage transformer, the voltage transformer being configured to perform AC-DC conversion of the AC power supply,
wherein the first voltage transformer performs AC-DC conversion between the AC power supply and the load power supply, and the second voltage transformer performs AC-DC conversion between the AC power supply and the logic power supply.

9. A method for performing a printing operation of a printer, comprising:
turning on an AC power supply and a logic power supply;
determining whether print data are received by the printer;
turning on a switching circuit by a control signal outputted from a control unit if the print data are received to a communication unit of the printer;
turning on a load power supply by supplying a current from the AC power supply to the load power supply;
performing the printing operation;
turning off the switching circuit by the control signal outputted from the control unit if subsequent print data are not received to the communication unit within a predetermined time;
turning off the load power supply; and
turning off the AC power supply and the logic power supply.

10. The method of claim 9, wherein the performing the printing operation comprising:
starting the printing operation by being supplied a current from the load power supply; and
finishing the printing operation and coming into a printing standby state.
